(19) United States
(12) Patent Application Publication
(10) Pub. No.: US 2012/0280779 A1
(43) Pub. Date: Nov. 8, 2012

(54) COMMON MODE CHOKE EMI FILTER OF AN LED DRIVER

(76) Inventor: Hsueh-Ming SHIH, Taipei (TW)

(21) Appl. No.: 13/098,820

(22) Filed: May 2, 2011

(51) Int. Cl. H01F 27/30

(52) U.S. Cl. 336/196

(57) ABSTRACT

A common mode choke EMI filter of an LED driver includes a holding structure, a plurality of winding magnetic cores, a first coil and a second coil. The holding structure has a plurality of holding spaces and a plurality of conductive pins. The winding magnetic cores are held in the holding spaces, and have respectively a first axle and a second axle. The first coil is wound on the first axles and straddles across different winding magnetic cores, and the second coil is wound on the second axles and straddles across other different winding magnetic cores. The holding structure includes a plurality of seats coupled in a juxtaposed manner through the first and second coils. By winding the first and second coils with greater length or diameter on the first and second axles of the winding magnetic cores, greater power or current adopted on a filter can be enhanced.

### FIELD OF THE INVENTION

The present invention relates to a common mode choke EMI filter of an LED driver and particularly to a filter including a plurality of different winding magnetic cores coupled through two coils respectively straddling across.

### BACKGROUND OF THE INVENTION

Electric power or signals are transmitted through media with different impedances in reality. Different electric power or signals also interfere with each other during transmission through the media. Because of the interference or attenuation, the electric power or signals are not naturally formed in ideal waveforms without noise. Hence filters are widely used in various types of electrical appliances, such as computers, televisions, hi-fi equipment and the like. The filter is mainly used to prevent electromagnetic interference (EMI) and filter out some noise, so it is an important component in industries today.

A conventional filter, such as R.O.C. patent No. M324274 entitled “Current-type common-mode filer” discloses a filter which includes an iron core and a cap. The iron core includes two horizontal axles parallel with each other and two connecting portions extended from and coupled with the axles. Each connecting portion has a plurality of contacts formed thereon. Each axle is wound by a coil set having at least one coil. The coil set has two ends extended to and soldered on the contacts of the connecting portions of the iron core. The cap is covered on the iron core.

While the aforesaid technique overcomes some conventional problems, it is constrained by the limited winding width of the winding magnetic core, and thus the number or the diameter of winding coils is restricted. Hence it is undesirable to be adopted on electrical appliances that require greater power and current. There is still room for improvement.

### SUMMARY OF THE INVENTION

In view of the limited power and current problems of the conventional filter, the primary object of the present invention is to provide a power line filter to expand power and current to meet requirements of electrical appliances that need greater power and current.

The present invention provides a common mode choke EMI filter of an LED driver that includes a holding structure, a plurality of winding magnetic cores, a first coil and a second coil. The holding structure has a plurality of holding spaces and a plurality of conductive pins on the periphery thereof. The winding magnetic cores are held in the holding spaces. Each winding magnetic core has two parallel bases, and a first axle and a second axle respectively connected to the bases at two distal ends. The first coil is wound on the first axles and straddles across different winding magnetic cores, and the second coil is wound on the second axles and straddles across other different winding magnetic cores. The seats are coupled in a juxtaposed manner through the first and the second coils.

Through the aforesaid structure, the first and second coils with greater length or diameter can be wound on the first and second axles of the winding magnetic cores. Therefore greater power or current adopted on a filter can be enhanced to meet requirements of electrical appliances that need greater power and current.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of a first embodiment of the invention.

FIG. 2 is a fragmentary sectional view of a winding magnetic core of the first embodiment of the invention.

FIG. 3 is a perspective view of the first embodiment of the invention.

FIG. 4 is another exploded view of the first embodiment of the invention.

FIG. 5 is a perspective view of a second embodiment of the invention.

FIG. 6 is an exploded view of a third embodiment of the invention.

FIG. 7 is a fragmentary sectional view of a winding magnetic core of the third embodiment of the invention.

FIG. 8 is a perspective view of a fourth embodiment of the invention.

### DETAILED DESCRIPTION OF THE PREFERRED EMBODIMENTS

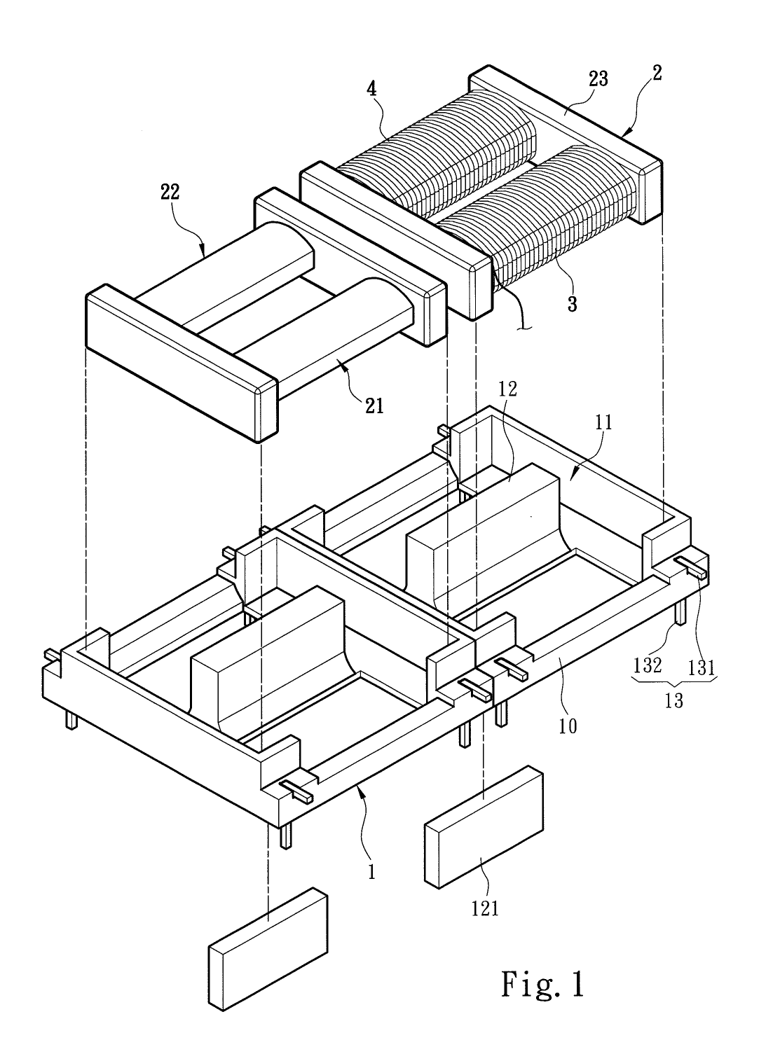

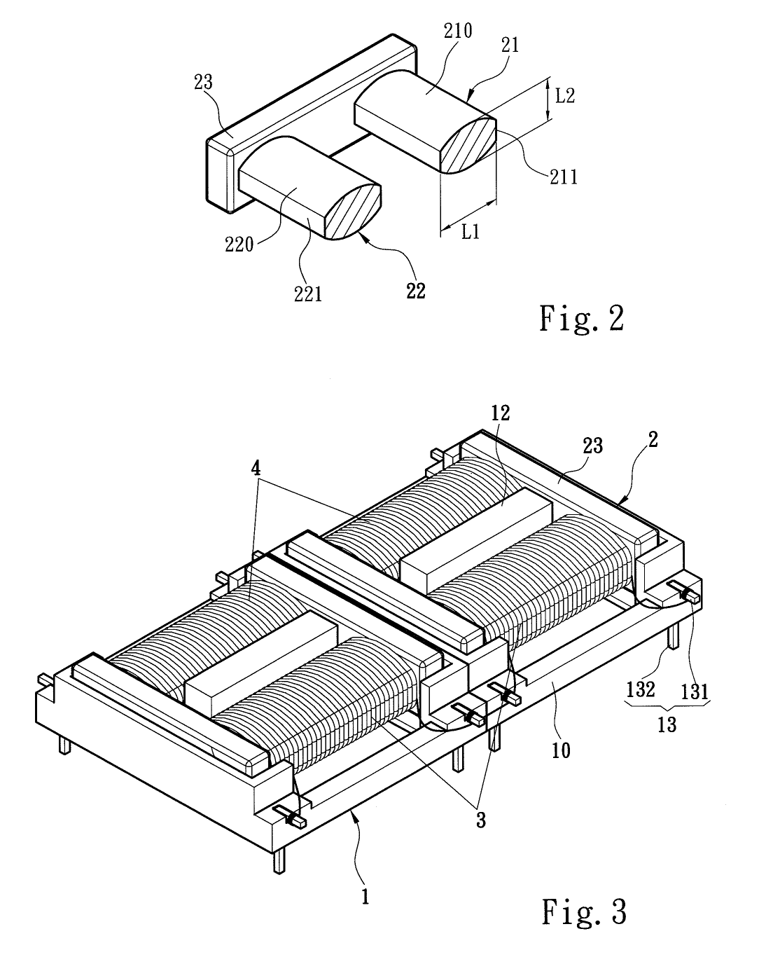

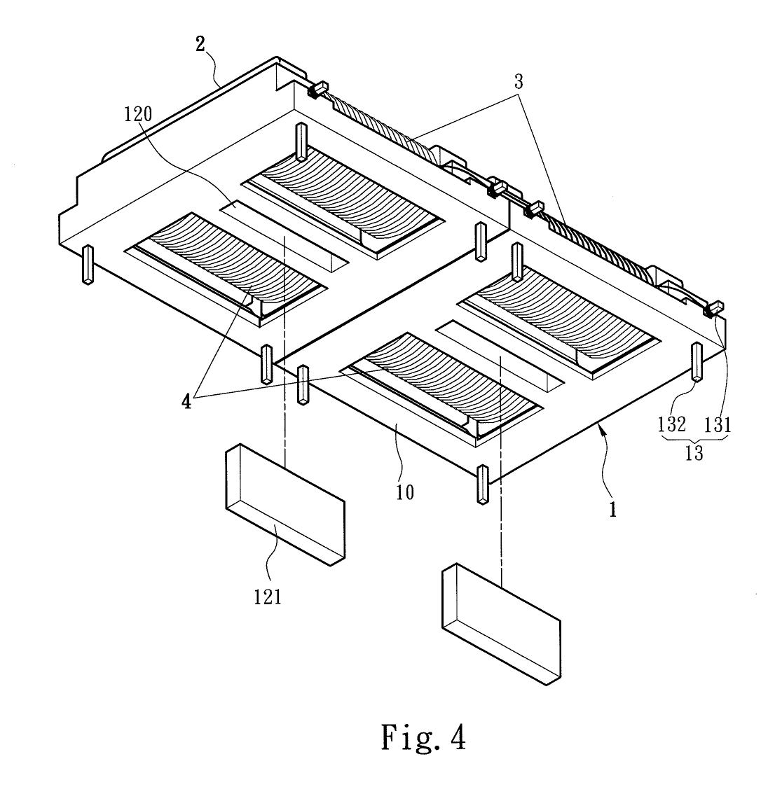

Please refer to FIGS. 1 through 4, the present invention provides a common mode choke EMI filter of an LED driver that includes a holding structure 1 and a plurality of winding magnetic cores 2. The holding structure 1 is divided into a plurality of holding spaces 11, and has a plurality of conductive pins 13 on the periphery and a plurality of seats 10 coupled with each other. Each seat 10 has one holding space 11 to hold one winding magnetic core 2 in a horizontal manner. In embodiments of the invention, each winding magnetic core 2 is formed in a rectangular shape and made of magnetic materials, and includes two parallel bases 23 and a first axle 21 and a second axle 22 respectively connected to the bases 23 at two distal ends. Referring to FIG. 2, the first and second axles 21 and 22 have respectively two first surfaces 210 or 220 mirror-symmetric to the center thereof, and form respectively an axle width L1 parallel with an extended direction of the long axis of the base 23 that is greater than the axle thickness L2 formed between the two first surface 210 or 220. The first and second axles 21 and 22 also have respectively two second surfaces 211 or 221 mirror-symmetric to the center thereof to bridge the two first surfaces 210 or 220 and form the axle width L1 therebetween. As shown in FIG. 2, the first surfaces 210 and 220 can be curved surfaces so that the first and second axles 21 and 22 are respectively formed in an elliptic shape with one elongated width in one direction and one narrow thickness in another direction. As a result, the first and second axles 21 and 22 can be compressed to become thinner to reduce total thickness of the filter of the invention to be applied to thinner products. The filter of the invention also includes a first coil 3 wound on the first axles 21 and straddling across a plurality of different winding magnetic cores 2, and a second coil 4 wound on the second axles 22 and straddling across a plurality of different winding magnetic cores 2 in the same manner of the first coil 3. The conductive pins 13 include a plurality of bracing pins 132 electrically connected to a circuit board (a technique known in the art, and thus is not shown in the drawings) and a plurality of bridging pins 131 to allow the first and second coils 3 and 4 to straddle across different winding magnetic cores 2. Hence different winding magnetic cores 2 can be coupled in a juxtaposed manner by winding the first and second coils 3 and 4 on different first axles 21 and second axles 22 through the bracing pins 131. The winding magnetic cores 2 may also be coupled by means of adhesive. The coupling technique that can be easily adopted by those skilled in the art shall be included in the scope of the invention. To improve the EMI problem between the first and second coils 3 and 4, the holding structure 1 further includes a plurality of isolation portions 12 interposed between the first and second axles 21 and 22 to prevent EMI. More specifically, referring to FIGS. 1 and 3, each isolation portion 12 is held in the holding space 11 of the seat 10 in a protrusive manner and has a trough 120 (referring to FIG. 4) to hold an EMI isolation element 121 made of nickel and zinc. By means of such construction, the holding structure 1 can include two seats 10 coupled in a juxtaposed manner to hold two winding magnetic cores 2 and increase the number of the first and second axles 21 and 22, thus can accommodate the first and second coils 3 and 4 with greater length or diameter to enhance applicable current and power of the filter.

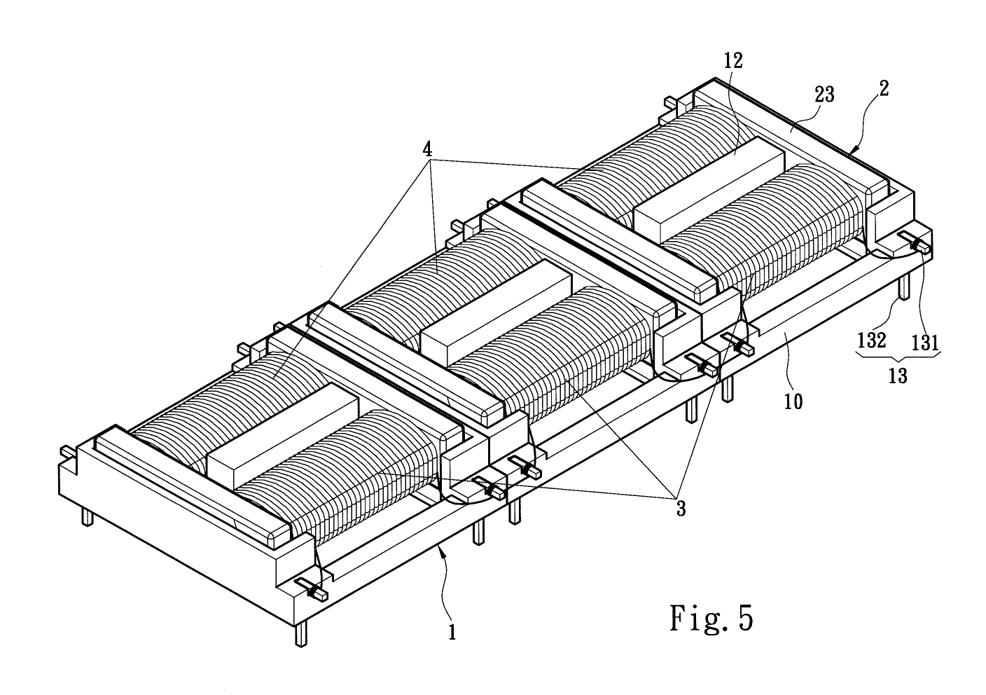

Through the technique previously discussed, multiple seats 10 can be coupled in a juxtaposed manner to form the holding structure 1 as depicted in the second embodiment shown in FIG. 5, in which the holding structure 1 includes three seats 10 coupled in a juxtaposed manner. The first coil 3 and the second coil 4 straddle across different winding magnetic cores 2 through the bridging pins 131, and hence the applicable power and current of the filter can be enhanced and expanded through the coupled holding structure 1.

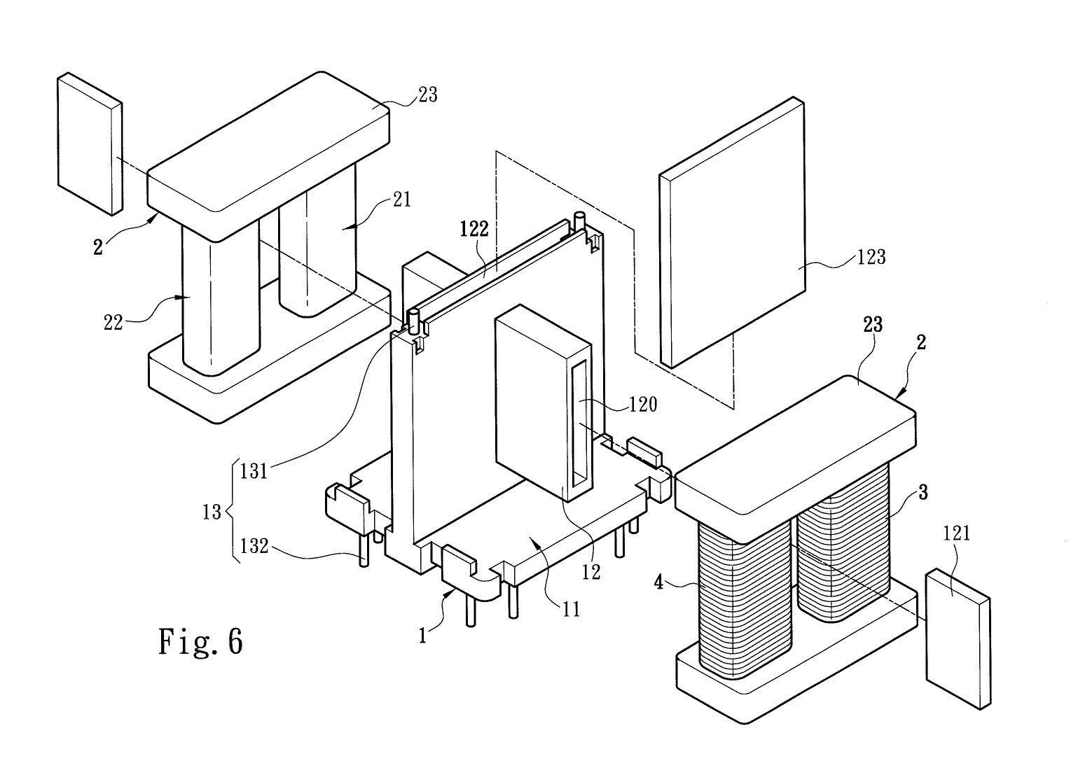

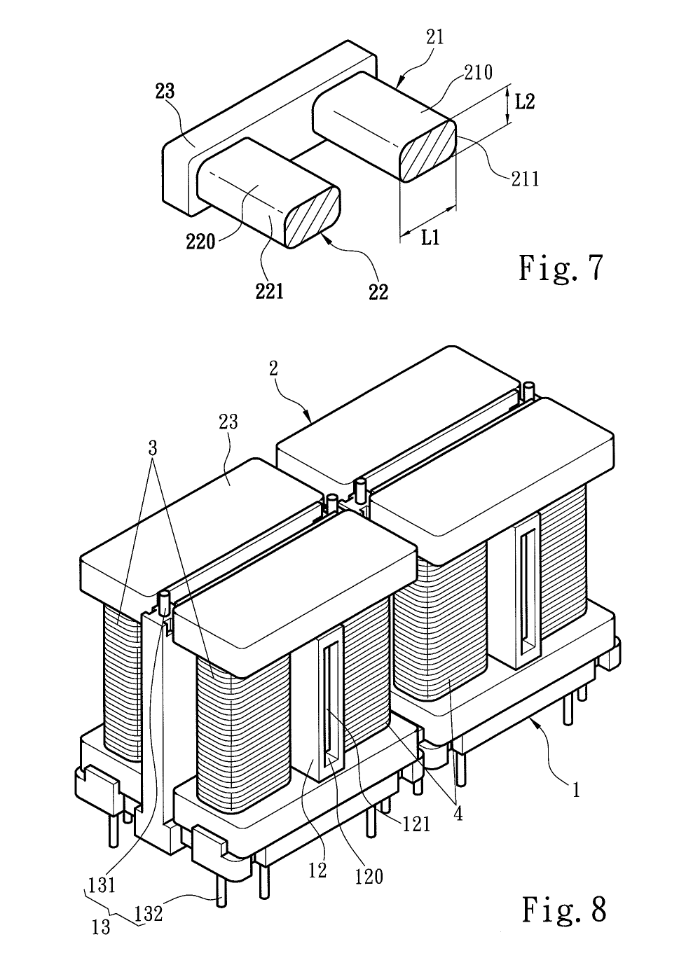

FIGS. 6 and 7 illustrate a third embodiment of the invention. The holding structure 1 is an integrated structure with the winding magnetic cores 2 held upright in the holding spaces 11 which are formed on two opposite sides of the holding structure 1. The holding structure 1 further has another trough 122 that also holds another EMI isolation element 123 to separate the two holding spaces 11. Each holding space 11 also holds an isolation portion 12 with a trough 120 formed inside to hold the EMI isolation element 121. The bridging pins 131 are located adjacent to the trough 122 to allow the first and second coils 3 and 4 to straddle across different winding magnetic cores 2. The upright winding magnetic cores 2 can achieve the purpose of increasing the applicable current and power of the filter, and also make space utilization better when being applied to an electrical appliance with an inadequate width. The winding magnetic core 2 also has a first axle 21 and a second axle 22 that have respectively two first surfaces 210 or 220 mirror-symmetric to the center thereof and two second surfaces 211 or 221 bridging to the first surfaces 210 or 220. The first surfaces 210 or 220 are spaced from each other to form the axle width L1 that is greater than the axle thickness L2 which is formed between the second surfaces 211 or 221. Furthermore, referring to FIGS. 6 and 7, the first surfaces 210 and 220 can be flat surfaces to form rectangular first and second axles 21 and 22 with one elongated width in one direction and one narrow thickness in another direction. Thus the thickness of the first and second axles 21 and 22 can be compressed to reduce the total thickness of the filter to be applied to thinner products.

The upright holding structure 1 can also include multiple seats 10 coupled in a juxtaposed manner to allow the first and second coils 3 and 4 to straddle across multiple different winding magnetic cores 2 (as shown in FIG. 8) to further enhance the applicable current and power of the filter. The conductive pin 13 can also be bent in right angle or in a zigzag fashion with multiple sections according to varying specification requirements.

While the invention has been described by means of specific embodiments, numerous modifications and variations could be made thereto by those skilled in the art without departing from the scope and spirit of the invention set forth in the claims.

In summation of the above description, the present invention provides a significant improvement over the conventional techniques and complies with the patent application requirements, and is submitted for review and granting of the commensurate patent rights.

What is claimed is:

1. A common mode choke EMI (Electromagnetic Interface) filter of an LED driver, comprising:
a holding structure including a plurality of separate holding spaces and a plurality of conductive pins on the periphery thereof;
a plurality of winding magnetic cores held in the holding spaces, each winding magnetic core including two parallel bases and a first axle and a second axle respectively connected to the bases at two distal ends; and
a first coil wound on the first axles and straddling across different winding magnetic cores, and a second coil wound on the second axles and straddling across other different winding magnetic cores.

2. The common mode choke EMI filter of claim 1, wherein the first axle and the second axle include respectively two first surfaces mirror-symmetric to the center thereof, and form respectively an axle width parallel with an extended direction of a long axis of the base that is greater than an axle thickness formed between the two first surfaces.

3. The common mode choke EMI filter of claim 2, wherein the first axle and the second axle further include respectively two second surfaces mirror-symmetric to the center thereof to bridge the two first surfaces and form the axle width therebetween.

4. The common mode choke EMI filter of claim 2, wherein the first surfaces are curved surfaces.

5. The common mode choke EMI filter of claim 2, wherein the first surfaces are flat surfaces.

6. The common mode choke EMI filter of claim 1, wherein the holding structure further includes a plurality of isolation portions between the first axle and the second axle to prevent electromagnetic interference.

7. The common mode choke EMI filter of claim 6, wherein each isolation portion includes a trough to hold an electromagnetic interference isolation element made of nickel and zinc.

8. The common mode choke EMI filter of claim 1, wherein the conductive pins include a plurality of bracing pins electrically connected to a circuit board and a plurality of bridging pins to allow the first coil and the second coil to bridge different winding magnetic cores in a straddling fashion.

9. The common mode choke EMI filter of claim 8, wherein the holding structure is formed in an integrated manner.

10. The common mode choke EMI filter of claim 8, wherein the holding structure includes a plurality of seats coupled with each other, each seat holding the bracing pins and the bridging pins, the seats being coupled in a juxtaposed fashion by winding the first coil and the second coil on different winding magnetic cores through the bridging pins.

11. The common mode choke EMI filter of claim 1, wherein the winding magnetic cores are held horizontally in the holding spaces.

12. The common mode choke EMI filter of claim 1, wherein the winding magnetic cores are held upright in the holding spaces.
